(19) United States
(12) Patent Application Publication
(10) Pub. No.: US 2018/0135713 A1
(43) Pub. Date: May 17, 2018

(54) Brake With a Reed Switch for Indicating an Operating Condition of the Brake

(71) Applicant: Warner Electric Technology LLC, Braintree, MA (US)

(72) Inventors: Stephen E. Nyquist, Simsbury, CT (US); Bradley Lyn Uffelman, Caro, MI (US)

(21) Appl. No.: 15/868,440

(22) Filed: Jan. 11, 2018

Related U.S. Application Data
(63) Continuation-in-part of application No. 14/620,355, filed on Feb. 12, 2015, now Pat. No. 9,903,429.

(51) Int. Cl. F16D 66/02; F16D 59/02; F16D 55/28

(52) U.S. Cl. CPC F16D 66/022; F16D 59/02; F16D 2121/22; F16D 66/028; F16D 55/28

(57) ABSTRACT

A brake is provided that employs an electromagnetic or magnetic circuit to disengage the brake and in which a reed switch is used to indicate an operating condition of the brake. The reed switch is positioned across an air gap between two members of the electromagnetic or magnetic circuit. The state of the reed switch changes in response to flux leakage at the air gap and may be used to monitor for potential failures in the operation of the brake including a failure to operate due a lack of current or the failure of the brake to disengage due to an obstruction.

### CROSS-REFERENCE TO RELATED APPLICATIONS

This application is a continuation-in-part of U.S. patent application Ser. No. 14/620,355 filed Feb. 12, 2015, the entire disclosure of which is incorporated herein by reference.

### BACKGROUND OF THE INVENTION

a. Field of the Invention

This disclosure relates to a brake. In particular, the instant disclosure relates to a brake that employs an electromagnetic or magnetic circuit to disengage the brake and in which a reed switch is oriented in a particular manner adjacent an air gap in the circuit to indicate an operating condition of the brake.

b. Background Art

One conventional type of brake used in industrial applications includes a friction plate or disc that is coupled to a rotating member. Springs bias a non-rotating armature plate into engagement with the friction plate in order to engage the brake. A conductor and/or magnets are then used to create an electromagnetic or magnetic circuit to draw the armature plate away from the friction plate when it is desired to disengage the brake.

The above-described brakes work well for their intended purpose. Occasionally, however, the brake will fail to operate properly. For example, a coil, lead wire, or other conductor carrying current to or within the brake may break preventing delivery of current to the brake. The brake may also fail to disengage as intended despite the creation of the electromagnetic or magnetic circuit due to, for example, wear on components of the brake (which may increase the distance between the armature plate and other components forming the electromagnetic or magnetic circuit) or the presence of foreign objects that prevent movement of the armature plate. In many applications, particularly where the brake is not visible or in highly automated systems, a failure of the brake is not readily apparent to a user and/or the system in which the brake is installed. As a result, an undesirable expenditure of resources (e.g., employee time and/or system downtime) is required to diagnose the problem in a particular application resulting from the malfunctioning brake.

The inventor herein has recognized a need for a brake that will minimize and/or eliminate one or more of the above-identified deficiencies.

### BRIEF SUMMARY OF THE INVENTION

A brake is provided. In particular, a brake is provided that employs an electromagnetic or magnetic circuit to disengage the brake and in which a reed switch is oriented in a particular manner adjacent an air gap in the circuit to indicate an operating condition of the brake.

A brake in accordance with one embodiment of the invention includes a friction plate configured for coupling to a shaft for rotation with the shaft about an axis of rotation, a pressure plate disposed about the axis on a first side of the friction plate and fixed against rotation and an armature plate disposed about the axis on a second side of the friction plate. The brake further includes a field shell disposed about the axis on an opposite side of the armature plate relative to the friction plate. The brake further includes a spring biasing the armature plate in a first axial direction towards the friction plate and away from the field shell to engage the brake. The brake further includes a conductor disposed within the field shell. Current supplied to the conductor creates an electromagnetic circuit including the armature plate and the field shell. The electromagnetic circuit urges the armature plate in a second axial direction away from the friction plate and towards the field shell to disengage the brake. The brake further includes a reed switch extending across an air gap between first and second members of the electromagnetic circuit, a state of the reed switch indicative of an operating condition of the brake.

A brake in accordance with another embodiment of the invention includes a friction plate configured for coupling to a shaft for rotation with the shaft about an axis of rotation, a pressure plate disposed about the axis on a first side of the friction plate and fixed against rotation and an armature plate disposed about the axis on a second side of the friction plate. The brake further includes a field shell disposed about the axis on an opposite side of the armature plate relative to the friction plate. The brake further includes a spring biasing the armature plate in a first axial direction towards the friction plate and away from the field shell to engage the brake. The brake further includes a conductor disposed within the field shell. Current supplied to the conductor creates an electromagnetic circuit including the armature plate and the field shell. The electromagnetic circuit urges the armature plate in a second axial direction away from the friction plate and towards the field shell to disengage the brake. The brake further includes a reed switch extending across an air gap between first and second members of the electromagnetic circuit, a state of the reed switch indicative of an operating condition of the brake. During proper operation of the brake, the reed switch undergoes a first transition from a first state to a second state when the brake is engaged and current begins flowing through the conductor and subsequently undergoes a second transition from the second state back to the first state once the brake is disengaged.

A brake in accordance with another embodiment of the invention includes a friction plate configured for coupling to a shaft for rotation with the shaft about an axis of rotation, a pressure plate disposed about the axis on a first side of the friction plate and fixed against rotation and an armature plate disposed about the axis on a second side of the friction plate. The brake further includes a field shell disposed about the axis on an opposite side of the armature plate relative to the friction plate, the field shell including first and second components. The brake further includes a spring biasing the armature plate in a first axial direction towards the friction plate and away from the field shell to engage the brake. The brake further includes a permanent magnet disposed between the first and second components of the field shell and forming a magnetic circuit with the first and second components of the field shell and the armature plate. The magnetic circuit urges the armature plate in a second axial direction away from the friction plate and towards the field shell to disengage the brake. The brake further includes a reed switch extending across an air gap between first and second members of the magnetic circuit, a state of the reed switch indicative of an operating condition of the brake.

A brake in accordance with the present teachings is advantageous relative to conventional brakes because it provides an effective, low cost indication of the operation of the brake. As a result, a user of the brake and/or the system in which the brake is installed is capable of readily identifying a malfunction of the brake without a significant expenditure of time.

The foregoing and other aspects, features, details, utilities, and advantages of the invention will be apparent from reading the following detailed description and claims, and from reviewing the accompanying drawings illustrating features of this invention by way of example.

### BRIEF DESCRIPTION OF THE DRAWINGS

FIG. 1 is a diagrammatic view of a brake in accordance with one embodiment of the present invention and a system for controlling and monitoring the brake.

FIG. 2 is a cross-sectional view of the brake of FIG. 1.

FIG. 3 is a perspective view of a brake in accordance with another embodiment of the present invention and a system for controlling and monitoring the brake.

FIG. 4 is a cross-sectional view of the brake of FIG. 3.

FIG. 5 is a graph illustrating changes in a current level in a conductor and in a state of a switch in the brake of FIGS. 1-2 over time during proper operation of the brake.

FIG. 6 is a graph illustrating changes in a current level in a conductor and in a state of a switch in the brake of FIGS. 1-2 over time during one type of failure in the brake.

### DETAILED DESCRIPTION OF THE INVENTION

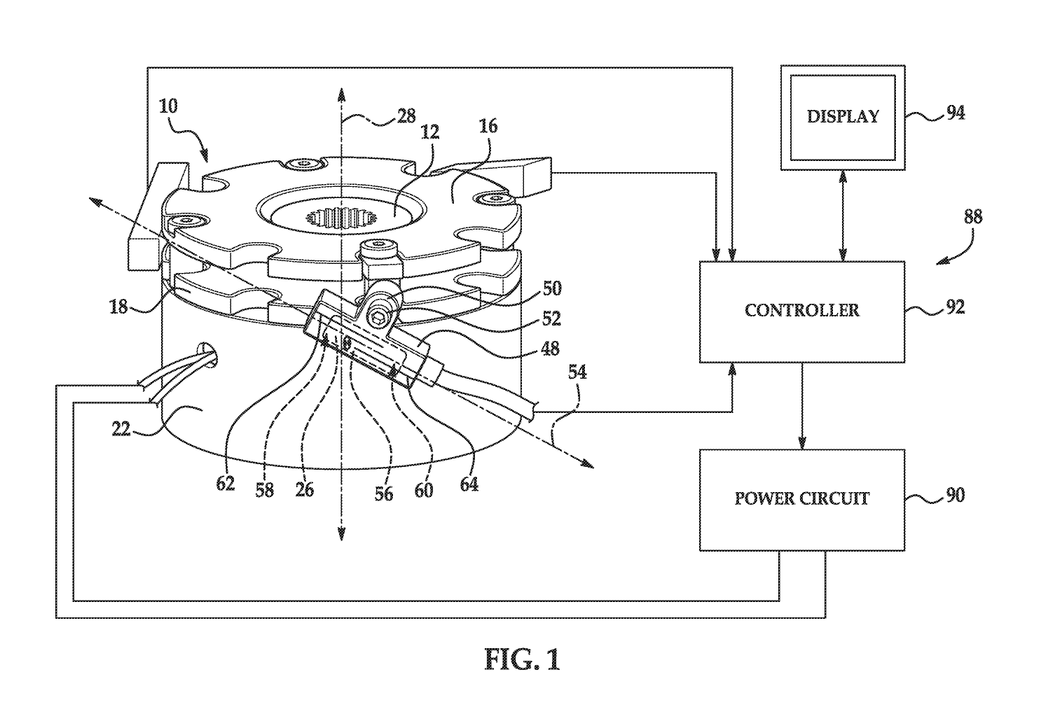

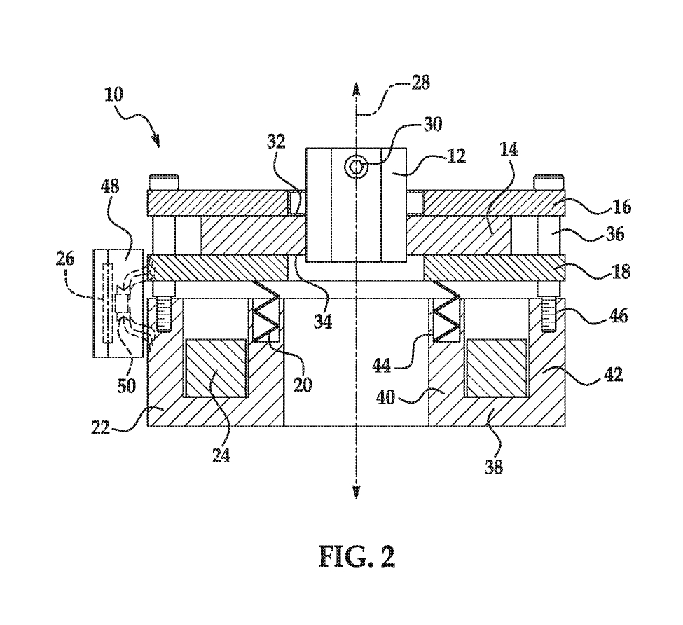

Referring now to the drawings wherein like reference numerals are used to identify identical components in the various views, FIG. 1-2 illustrate brake 10 in accordance with one embodiment of the invention. Brake 10 provides a braking torque to a rotating body such as a shaft, gear, pulley, blade, etc. in order to slow or halt rotation of the rotating body. It will be understood by those of ordinary skill in the art that brake 10 may be used in a wide variety of industrial and other applications requiring a brake. Brake 10 may include a hub 12, a friction plate 14, a pressure plate 16, and armature plate 18, means, such as springs 20, for biasing armature plate 18 in one direction and means, such as field shell 22 and conductor 24, for urging armature plate 18 in another direction. In accordance with the present teachings, brake 10 may further include one or more reed switches 26. The state of each reed switch 26 is indicative of an operating condition of brake 10.

Hub 12 is configured for coupling to a rotating body such as a shaft (not shown) and supports friction plate 14. Hub 12 may be made from conventional plastics or metals. Hub 12 is annular and is disposed about the rotating shaft and an axis 28 of rotation for the shaft. Hub 12 may be coupled to the shaft in a variety of ways. For example, hub 12 may define a key or keyway configured for alignment with a complementary keyway or key in the shaft. Hub 12 may alternatively include a plurality of splines or teeth configured to mesh with mating splines or teeth on the shaft. Alternatively still, a set screw 30 may be inserted through a radially extending aperture in hub 12 and engage the shaft. Hub 12 may also form a unitary structure with the shaft. The radially outer surface of hub 12 may define a plurality of flats for engagement with corresponding flats on friction plate 14.

Friction plate 14 is provided to transmit a braking torque to hub 12 and the shaft or other rotating body and is configured for coupling to the shaft (e.g. through hub 12) for rotation with the shaft about axis 28. Friction plate 14 may be made from conventional metals or plastics and may be made by stamping, molding and/or machining. Friction plate 14 may be annular in shape and disposed about hub 12 and axis 28. Friction plate 14 is configured for rotation with hub 12 and may be rotationally coupled to hub 12 in a variety of ways that permit axial movement of friction plate 14 relative to hub 12 to enable proper operation of brake 10 and account for wear, vibration, runout or thermal expansion. For example, the radially inner surface of friction plate 14 and the radially outer surface of hub 12 may have complementary, torque transmitting, shapes such as a key and keyway, splines, single or double D-shape or hexagonal shape. Friction plate 14 may also be coupled to hub 12 using leaf springs. In certain applications (typically low speed applications, applications with low to zero lash requirements and/or applications that permit light frictional drag during release of the brake), friction plate 14 may be combined with hub 12 as a unitary structure or coupled to hub 12 in a way that does not permit relative axial movement (e.g., an interference fit or through adhesives or other fasteners). Friction plate 14 includes friction surfaces on opposed sides 32, 34 configured to engage pressure plate 16 and armature plate 18, respectively, during engagement of brake 10.

Pressure plate 16 is configured to engage friction plate 14 during application of brake 10 to transmit a braking torque to friction plate 14. Pressure plate 16 provides a reaction surface against which armature plate 18 presses friction plate 14 during application of brake 10. Pressure plate 16 may be made from conventional metals or plastics and may be made from steel (including stainless steel) in some embodiments. Pressure plate 16 is disposed on side 32 of friction plate 14. Pressure plate 16 may further be disposed about hub 12 and axis 28. Pressure plate 16 is fixed against rotation and may be coupled to field shell 22 using a plurality of axially extending fasteners 36 such as bolts, pin, screws or the like.

Armature plate 18 is also configured to engage friction plate 14 during application of brake 10 to transmit a braking torque to friction plate 14. Armature plate 18 may be made from metals or metal alloys or other materials having relatively low magnetic reluctance such as iron or steel. Armature plate 18 is disposed on side 34 of friction plate 14. Armature plate 18 may further be disposed about hub 12 and axis 28. Armature plate 18 is fixed against rotation, but is axially movable towards and away from friction plate 14 and pressure plate 16 to permit engagement and disengagement of brake 10. Armature plate 18 may include a plurality of bores extending through armature plate 18 or a plurality of recesses in the radially outer surface of armature plate 18 configured to permit fasteners 36 to pass through armature plate 18. In this manner, fasteners 36 limit or prevent rotation of armature plate 18 about axis 28, but armature plate 18 is permitted to move along axis 28.

Springs 20 provide a means for biasing armature plate 18 in one direction along axis 28 towards friction plate 14 and pressure plate 16 to engage brake 10. Springs 20 may be disposed between field shell 22 and armature plate 18. It should be understood that brake 10 may include either a single annular spring 20 or a plurality of springs 20 disposed in an annular array about axis 28. In the latter case, springs 20 may be spaced equally circumferentially spaced about axis 28.

Field shell 22, together with conductor 24, provide a means for urging armature plate 18 in the opposite direction along axis 28 away from friction plate 14 and pressure plate 16 to disengage brake 10. Field shell 22 may also provide structural support and orient other components of brake 10 including pressure plate 16 and springs 20. Field shell 22 may be annular in shape and disposed about axis 28 and may be disposed on a side of armature plate 18 opposite friction plate 14. Field shell 22 may be made from materials having a relatively low magnetic reluctance such as ferromagnetic materials. Field shell 22 may define a radially extending end wall 38 and axially extending, radially aligned, inner and outer walls 40, 42 that extend axially from end wall 38 towards armature plate 18. Inner wall 40 may define one or more closed bores 44 configured to receive one end of each spring 20. Outer wall 42 may also define one or more closed bores 46 configured to receive fasteners 36. Conductor 24 may comprise a conventional wound coil or similar conductor and is configured to be received within field shell 22 between walls 40, 42. Current supplied to conductor 24 creates an electromagnetic circuit that includes armature plate 18 and field shell 22. This circuit urges armature plate 18 towards field shell 22 and away from friction plate 14 against the force of springs 20 to disengage brake 10.

In accordance with the present teachings, one or more reed switches 26 are provided that indicates an operating condition of brake 10. In the illustrated embodiment, three reed switches 26 are provided and are equally circumferentially spaced about a circumference of brake 10. Each switch 26 extends across an air gap between components of the electromagnetic circuit. In the illustrated embodiment, each switch 26 is disposed radially outwardly of armature plate 18 and field shell 22 and extends across the air gap between armature plate 18 and field shell 22 (and particularly, outer wall 42 of field shell 22). In the illustrated embodiment, switches 26 detects flux leakage from the electromagnetic circuit between armature plate 18 and field shell 22 when current has been supplied to conductor 24, but armature plate 18 has failed to disengage from friction plate 14. This circumstance may occur, for example because wear on one or more of plates 14, 16, 18 has increased the distance between armature plate 18 and field shell 22 such that the electromagnetic circuit is no longer sufficient to attract armature plate 18 to field shell 22. Alternatively, a foreign object or element may become lodged between armature plate 18 and field shell 22 and prevent movement of armature plate 18 in the direction of field shell 22. In these circumstances, the distance between armature plate 18 and field shell 22 will result in flux leakage within the circuit and an increased magnetic field strength proximate switches 26 thereby causing switches 26 to assume a closed state and thereby providing an indication that the brake is not functioning properly. In all other circumstances (e.g., when current is not being supplied to conductor 24 or when current is being supplied to conductor 24, but armature plate 18 properly disengages from friction plate 14 and engages field shell 22 to minimize the air gap between armature plate 18 and field shell 22), switches 26 will remain in an open state.

Each switch 26 may be mounted within a housing 48 that may be coupled to brake 10. In the illustrated embodiment housing 48 has a generally rectangular, box-like shape with a mounting flange 50 extending therefrom that is configured to receive a fastener 52 used to couple the housing 48 to brake 10. Housing 48 may be made from aluminum and helps to orient reed switch 26 relative to brake 10 and the air gap between armature plate 18 and field shell 22 (it should be understood, however, that switch 26 could be oriented relative to brake 10 using a variety of structures and/or coupling methods in place of housing 48). In accordance with the present teachings, each switch 26 is oriented such that a longitudinal axis 54 of the switch 26 extends in a direction other than parallel to axis 28. The longitudinal axis 54 of switch 26 is an axis that extends through and within a hermetically sealed glass chamber 56 of the switch 26 between the opposite longitudinal ends 58, 60 of chamber 56. The longitudinal ends 58, 60 of the chamber also define the points at which the ferromagnetic reeds 62, 64 of switch 26 enter the chamber 56. The longitudinal axis 54 of switch 26 will also intersect a plane containing axis 28 (the plane lying perpendicular to the drawing) at an angle θ between zero and ninety degrees. In accordance with one embodiment, axis 54 intersects the plane at an angle θ of about eighty degrees. The preferred angle in a given application will depend on several factors including the size of brake 10, available mounting envelope for switch 26, anticipated vibration, the number of turns in a coil conductor 24 and current level, the operating environment for brake 10 (including nearby electromagnetic or magnetic devices and ferromagnetic structures) and the brake's magnetic iron circuit relative to electromagnet flux imbalance. As a result of its orientation, axis 54 also extends in a direction other than parallel to a direction of magnetic force at a point in the air gap where the magnetic force is greatest. Referring to FIG. 2, the magnetic force between armature plate 18 and wall 42 of field shell 22 will be greatest along the shortest path between armature plate 18 and wall 42 which is parallel to axis 28.

Orienting each switch 26 such that its longitudinal axis 54 is at an angle relative to the axis 28 enables more robust and reliable switching. In particular, the orientation reduces the sensitivity of switch 26 such that switch 26 only closes when there is a relatively high level of flux leakage proximate the air gap between armature plate 18 and field shell 22. As a result, switch 26 does not close when current is not supplied to conductor 24. Switch 26 also does not close when current is supplied to conductor 24 and armature plate 18 properly disengages from friction plate 14 and engages field shell 22—despite the existence of some flux leakage across the relatively small remaining air gap between armature plate 18 and field shell 22. Switch 26 only closes when current is supplied to conductor 24, but armature plate 18 improperly fails to disengage from friction plate 14—resulting in a relatively high level of flux leakage across the relatively large air gap between armature plate 18 and field shell 22. In this manner, switch 26 is able to indicate an improper operating condition of brake 10 while not generating false positives. The orientation of switch 26 also allows unwanted and inherent residual magnetism to drain from switch 26 to field shell 22 and other ferromagnetic components of the brake 10 when current is not being supplied to conductor 24 thereby preventing the contacts of switch 26 from inadvertently sticking and remaining closed. Further, the orientation of switch 26 accomplishes these results while allowing the switch 26 to be mounted close to the radially outer surface of field shell 22 and brake 10 in general thereby reducing the space required for switch 26 and the packaging of brake 10 while providing protection for switch 26.

Referring to FIG. 1, the performance of brake 10 may be controlled and monitored using system 88. System 88 may include a power circuit 90, a controller 92, and one or more input/output devices or interfaces such as a display 94. Power circuit 90 controls delivery of current from a power source such as a power grid or an energy storage device (e.g., a battery or capacitor) to conductor 24 in brake 10. Circuit 90 may include conventional switches and other circuit components used to control the flow and level of current to and from conductor 24. Controller 92 controls the operation of power circuit 90 and, therefore, brake 10 and monitors the performance of brake 10 through reed switches 26. Controller 92 may comprise a programmable microprocessor or microcontroller or may comprise an application specific integrated circuit (ASIC). Controller 92 may include a central processing unit (CPU). Controller 92 may also include a memory and an input/output (I/O) interface through which controller 92 may receive a plurality of input signals including those generated by reed switches 26 and display 94 and transmit a plurality of output signals including those used to control power circuit 90 and display 94. Display 94 provides a visual indication of an operation condition of brake 10. Display 94 may include a graphical user interface (GUI) that provides information output by controller 92 regarding the performance of brake 10 and that allows entry of commands to be input to controller 92 for use in controlling brake 10 (through, e.g., a touch screen component of display 94 or another input device such as a keyboard or mouse). It should be understood that a variety of input/output devices may be employed to indicate the operating condition of brake 10 including, for example, audio, visual or haptic alarms.

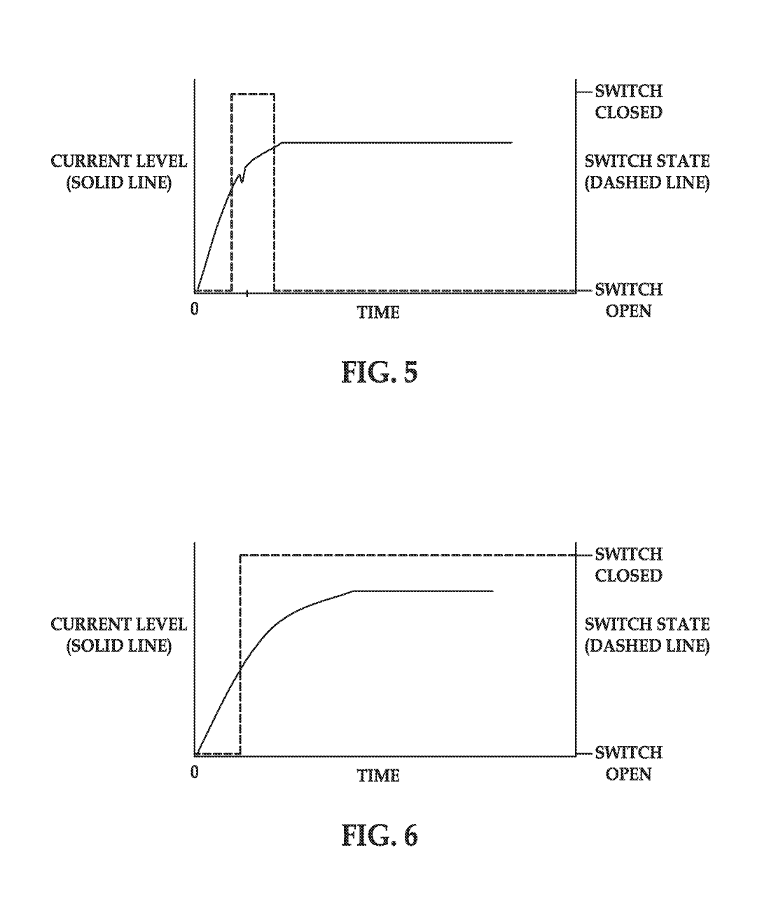

Referring to FIG. 5, during proper operation of brake 10, switches 26 will remain in an open state in the absence of any current in conductor 24. In the absence of current in conductor 24, springs 20 urge armature plate 18 into engagement with friction plate 14 to engage brake 10. When it is desired to disengage brake 10, controller 92 directs power circuit 90 to provide current to conductor 24 and the level of current in conductor 24 begins to increase. Because armature plate 18 is still engaged with friction plate 14 and spaced from field shell 20 across a relatively large air gap, significant flux leakage occurs across the air gap between armature plate 18 and field shell 20. The flux leakage briefly causes switch 26 to transition from the open state to a closed state. The absence of this transition is indicative of a lack of current in conductor 24 (e.g. because a break has occurred in conductor 24 or a lead wire to conductor 24). Controller 92 may detect the absence of this transition in reed switches 26 (e.g., due to the failure of the switches 26 to transition from the open state to the close state within a predetermined period of time) and generate a signal indicative of a lack of current in conductor 24. This signal may, for example, cause a change in display 94 and thereby provide an indication to an operator of a failure in brake 10. Assuming that current flows to conductor 24, when the level of current in conductor 24 reaches a sufficient amount, the electromagnetic circuit among armature plate 18 and field shell 20 overcomes the biasing force of springs 20 and causes armature plate 18 to disengage from friction plate 14 and to engage field shell 20 thereby disengaging brake 10—and reducing the size of the air gap between armature plate 18 and field shell 20. Flux leakage from the air gap between armature plate 18 and field shell 20 decreases as a result of the reduced air gap thereby causing reed switches 26 to transition from the closed state back to the open state. Referring to FIG. 6, when brake 10 fails to disengage due to, for example, wear on armature plate 18 and field shell 20 that increases the distance between armature plate 18 and field shell 20 or the presence of foreign objects that prevent movement of armature plate 18, one or more of switches 26 will fail to transition back to the open state and will remain in the closed state. Controller 92 may detect the absence of this transition in reed switches 26 (e.g., due to the failure of the switches 26 to transition from the closed state back to the open state within a predetermined period of time) and generate a signal indicative of a failure to disengage by the brake. This signal may again, for example, cause a change in display 94 and thereby provide an indication to an operator of a failure in brake 10.

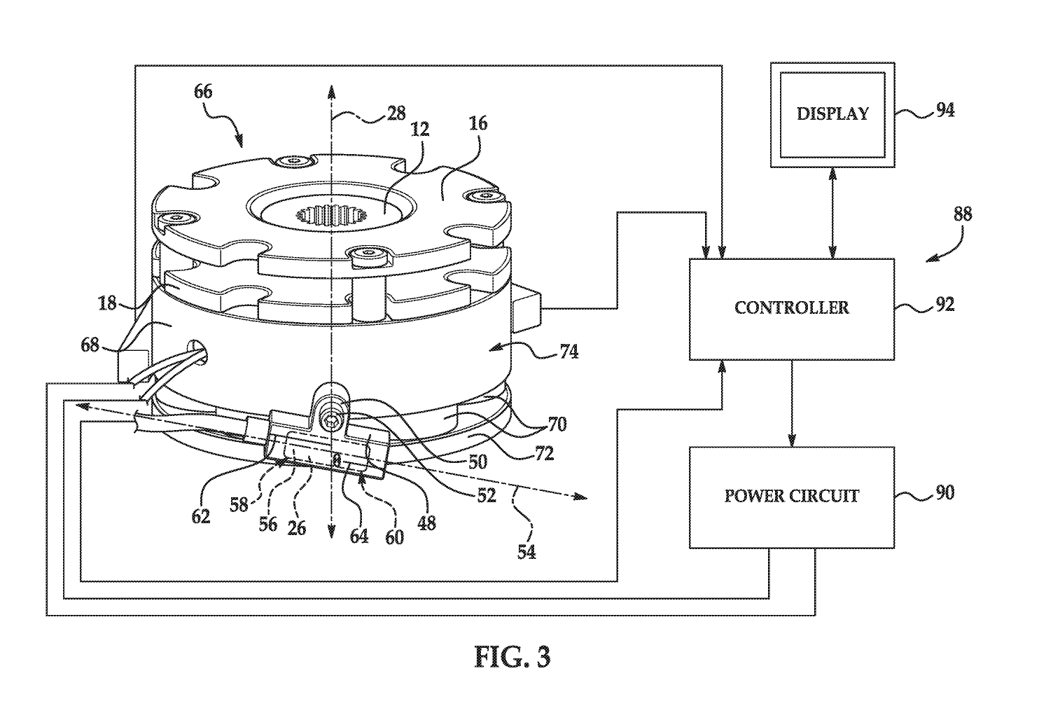

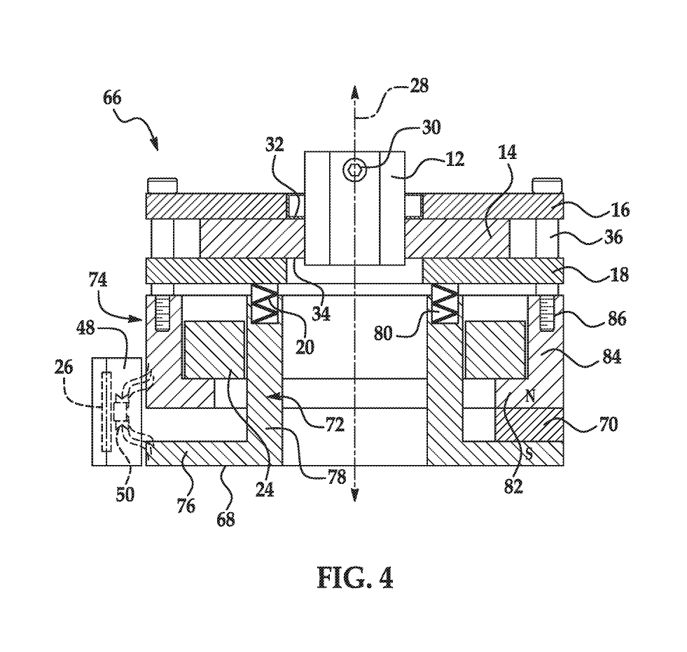

Referring now to FIGS. 3-4, a brake 66 in accordance with another embodiment of the present teachings is illustrated. Many components of brake 10—including hub 12, friction plate 14, pressure plate 16 armature plate 18, springs 20 and conductor 24—may also be used within brake 66. Therefore, the same numbers are used in FIGS. 3-4 to represent structure that may be common to brakes 10 and 66. Brake 66 differs from brake 10 in the structure of the included field shell 68, the addition of one or more magnets 70, and the resulting operation of brake 66.

Field shell 68, together with magnets 70, provide a means for urging armature plate 18 in the opposite direction along axis 28 away from friction plate 14 and pressure plate 16 in order to disengage brake 66. Field shell 68 may also provide structural support and orient other components of brake 66 including pressure plate 16 and springs 20. Field shell 68 may be annular in shape and disposed about axis 28 and may be disposed on a side of armature plate 18 opposite friction plate. Field shell 68 may be made from materials having a relatively low magnetic reluctance such as ferromagnetic materials. Field shell 68 may include two components 72, 74. Component 72 may define a radially extending end wall 76 an axially extending, radially inner wall 78 that extends from end wall 76 towards armature plate 18. Wall 78 may define one or more closed bores 80 configured to receive one end of each spring 20. Component 74 is disposed radially outwardly of wall 78 of component 72. Component 74 may define a radially extending wall 82 that is axially spaced from wall 76 of component 72 and an axially extending, radially outer wall 84 that extends from end wall 82 towards armature plate 18. Outer wall 84 may also define one or more closed bores 86 configured to receive fasteners 36. Walls 76, 82 are axially spaced and sized to receive magnet 70 therebetween. Walls 78, 84 are radially spaced and sized to receive conductor 24 therebetween.

Magnets 70 are provided to establish a magnetic circuit between armature plate 18, field shell 68 and magnets 70 in order to urge armature plate 18 in an axial direction away from friction plate 14 and pressure plate 16 and towards field shell 68 to release brake 66. Magnets 70 may comprise neodymium iron boron (Nd—Fe—B) magnets or other known permanent magnets. Magnets 70 may be disposed axially between walls 76, 82 of components 72, 74 of field shell 68 and may be secure therein using an adhesive. Magnets 70 may be equally circumferentially spaced from one another about the circumferential extent of brake 66.

Unlike brake 10, brake 66 is a bi-stable brake in which supplying a short duration current to conductor 24 causes the brake 66 to move between an engaged and disengaged state and to remain in that state until current is supplied to conductor 24 again. If, for example, brake 66 is engaged with armature plate 18 engaging friction plate 14 under the force exerted by springs 20, current of a first polarity may be provided to conductor 24 to increase the force of the magnetic circuit comprising armature plate 18, field shell 68 and magnets 70 and cause armature plate 18 to move away from friction plate 14 towards field shell 68 and engage field shell 68 to release brake 66. Thereafter, the current supply can be interrupted and armature plate 18 will remain engaged with field shell 68 under the force exerted by the magnetic circuit. Current of an opposite polarity may then be provided to conductor 24 when it is desired to reapply brake 66. The current weakens the magnetic attraction of the magnetic circuit and allows springs 20 to urge armature plate 18 away from field shell 68 towards friction plate 14 to engage brake 66.

In accordance with the present teachings, one or more reed switches 26 are again provided to indicate an operating state of brake 66. In the illustrated embodiment, three reed switches 26 are provided and are equally circumferentially spaced about a circumference of brake 66. Switches 26 extends across an air gap between members of the magnetic circuit. In the illustrated embodiment, switches 26 are disposed radially outwardly of components 72, 74 of field shell 68 and extends across the air gap between components 72, 74. In the illustrated embodiment, switches 26 detects flux leakage from the magnetic circuit comprising armature plate 18, field shell 68 and magnets 70. In particular, when the brake is engaged and armature plate 18 is spaced from field shell 68, the magnetic flux leakage between components 72, 74 is greater than when the brake is disengaged and armature plate 18 is engaged with field shell 68. Each time brake 66 moves between engaged and disengaged states, movement of armature plate 18 causes a shift in the magnetic reluctance across the air gap between components 72, 74 that results in a change in state of switch 26. When brake 66 is engaged, switch 26 assumes a closed state indicating that the armature plate 18 is disengaged from field shell 68 and engaging friction plate 14 and brake 66 is engaged. When brake 66 is disengaged, switch 26 assumes an open state indicating that the armature plate 18 is engaged with field shell 68 and brake 66 is disengaged.

Referring to FIG. 3, in accordance with the present teachings, switches 26 are again oriented such that a longitudinal axis 54 of each switch 26 extends in a direction other than parallel to axis 28 of brake 66. The longitudinal axis 54 of switch 26 will also intersect a plane containing axis 28 (the plane lying perpendicular to the drawing) at an angle θ between zero and ninety degrees. The preferred angle in a given application will depend on several factors including the size of brake 66, available mounting envelope for switch 26, anticipated vibration, the number of turns in a coil conductor 24 and current level, the operating environment for brake 66 (including nearby electromagnetic or magnetic devices and ferromagnetic structures) and the brake's magnetic iron circuit relative to electromagnet flux imbalance. As a result of its orientation, axis 54 also extends in a direction other than parallel to a direction of magnetic force at a point in the air gap where the magnetic force is greatest. Referring to FIG. 4, the magnetic force between components 72, 74 of field shell 68 will be greatest along the shortest path between components 72, 74 which is parallel to axis 28.

Orienting each switch 26 such that its longitudinal axis 54 is at an angle relative to the axis 28 again enables more robust and reliable switching. In particular, the orientation again reduces the sensitivity of switch 26 such that switch 26 only closes when there is a relatively high level of flux leakage proximate the air gap between components 72, 74 of field shell 68. As a result, switch 26 only closes when current is supplied to conductor 24, but armature plate 18 improperly fails to disengage from friction plate 14—resulting in a relatively high level of flux leakage across the relatively large air gap between components 72, 74. In this manner, switch 26 is able to indicate an improper operating condition of brake 66 while not generating false positives. The orientation of switch 26 also allows unwanted and inherent residual magnetism to drain from switch 26 to field shell 68 and other ferromagnetic components of the brake 10 when current is not being supplied to conductor 24 thereby preventing the contacts of switch 26 from inadvertently sticking and remaining closed. Further, the orientation of switch 26 accomplishes these results while allowing the switch 26 to be mounted close to the radially outer surface of field shell 68 and brake 66 in general thereby reducing the space required for switch 26 and the packaging of brake 66 while providing protection for switch 26.

A brake 10 or 66 in accordance with the present teachings is advantageous relative to conventional brakes because it provides an effective, low cost indication of the operation of the brake. As a result, a user of the brake and/or the system in which the brake is installed is capable of readily identifying a malfunction of the brake without a significant expenditure of time.

While the invention has been shown and described with reference to one or more particular embodiments thereof, it will be understood by those of skill in the art that various changes and modifications can be made without departing from the spirit and scope of the invention.

What is claimed is:

1. A brake, comprising:
a friction plate configured for coupling to a shaft for rotation with the shaft about an axis of rotation;
a pressure plate disposed about the axis on a first side of the friction plate and fixed against rotation;
an armature plate disposed about the axis on a second side of the friction plate;
a field shell disposed about the axis on an opposite side of the armature plate relative to the friction plate;
a spring biasing the armature plate in a first axial direction towards the friction plate and away from the field shell to engage the brake;
a conductor disposed within the field shell, current supplied to the conductor creating an electromagnetic circuit including the armature plate and the field shell, the electromagnetic circuit urging the armature plate in a second axial direction away from the friction plate and towards the field shell to disengage the brake; and,
a first reed switch extending across an air gap between first and second members of the electromagnetic circuit, a state of the first reed switch indicative of an operating condition of the brake.

2. The brake of claim 1 wherein a longitudinal axis of the first reed switch extends in a direction other than parallel to the axis of rotation.

3. The brake of claim 1 wherein the first and second members of the electromagnetic circuit comprise the armature plate and the field shell.

4. The brake of claim 3 wherein the reed switch is disposed radially outwardly of the armature plate and the field shell.

5. The brake of claim 1 wherein the longitudinal axis of the first reed switch extends in a direction other than parallel to a direction of a magnetic force at a point in the air gap where the magnetic force is greatest.

6. The brake of claim 1 wherein the first reed switch is adjacent to the air gap and configured to detect flux leakage at the air gap when the armature plate is spaced from the field shell.

7. A brake, comprising:
a friction plate configured for coupling to a shaft for rotation with the shaft about an axis of rotation;
a pressure plate disposed about the axis on a first side of the friction plate and fixed against rotation;
an armature plate disposed about the axis on a second side of the friction plate;
a field shell disposed about the axis on an opposite side of the armature plate relative to the friction plate;
a spring biasing the armature plate in a first axial direction towards the friction plate and away from the field shell to engage the brake;
a conductor disposed within the field shell, current supplied to the conductor creating an electromagnetic circuit including the armature plate and the field shell, the electromagnetic circuit urging the armature plate in a second axial direction away from the friction plate and towards the field shell to disengage the brake; and,
a first reed switch extending across an air gap between first and second members of the electromagnetic circuit, a state of the first reed switch indicative of an operating condition of the brake
wherein, during proper operation of the brake, the first reed switch undergoes a first transition from a first state to a second state when the brake is engaged and current begins flowing through the conductor and subsequently undergoes a second transition from the second state back to the first state once the brake is disengaged.

8. The brake of claim 7, further comprising a controller coupled to the first reed switch and configured to generate a signal indicative of a lack of current in the conductor when the first reed switch fails to undergo the first transition.

9. The brake of claim 8, wherein the controller is configured to generate a signal indicative of a failure to disengage by the brake when the first reed switch fails to undergo the second transition.

10. The brake of claim 7, further comprising a controller configured to generate a signal indicative of a failure to disengage by the brake when the first reed switch fails to undergo the second transition.

11. The brake of claim 7, further comprising a second reed switch extending across the air gap between the first and second members of the electromagnetic circuit, the second reed switch circumferentially spaced from the first reed switch and a state of the second reed switch indicative of an operating condition of the brake.

12. The brake of claim 7 wherein a longitudinal axis of the first reed switch extends in a direction other than parallel to the axis of rotation.

13. A brake, comprising:
a friction plate configured for coupling to a shaft for rotation with the shaft about an axis of rotation;
a pressure plate disposed about the axis on a first side of the friction plate and fixed against rotation;
an armature plate disposed about the axis on a second side of the friction plate;
a field shell disposed about the axis on an opposite side of the armature plate relative to the friction plate, the field shell including first and second components;
a spring biasing the armature plate in a first axial direction towards the friction plate and away from the field shell to engage the brake;
a permanent magnet disposed between the first and second components of the field shell and forming a magnetic circuit with the first and second components of the field shell and the armature plate, the magnetic circuit urging the armature plate in a second axial direction away from the friction plate and towards the field shell to disengage the brake; and,
a first reed switch extending across an air gap between first and second members of the magnetic circuit, a state of the first reed switch indicative of an operating condition of the brake.

14. The brake of claim 13 wherein a longitudinal axis of the first reed switch extends in a direction other than parallel to the axis of rotation.

15. The brake of claim 14 wherein the longitudinal axis of the first reed switch extends in a direction other than parallel to a direction of a magnetic force at a point in the air gap where the magnetic force is greatest.

16. The brake of claim 13 wherein the first and second members comprise the first and second components of the field shell.

17. The brake of claim 16 wherein the first reed switch is disposed radially outwardly of the first and second components of the field shell.

18. The brake of claim 13 wherein the first reed switch is adjacent to the air gap and configured to detect flux leakage at the air gap when the armature plate is spaced from the field shell.

19. The brake of claim 13 further comprising a conductor disposed within the field shell, current of a first polarity supplied to the conductor increasing a force of the magnetic circuit and current of a second polarity supplied to the conductor weakening the force of the magnetic circuit.

20. The brake of claim 13, further comprising a second reed switch extending across the air gap between the first and second members of the electromagnetic circuit, the second reed switch circumferentially spaced from the first reed switch and a state of the second reed switch indicative of an operating condition of the brake.
